(19) United States
(12) Patent Application Publication
(10) Pub. No.: US 2008/0003098 A1
(43) Pub. Date: Jan. 3, 2008

(54) Method for modification of a turbocompressor

(75) Inventor: Marco Micheli, Wettingen (CH)

Correspondence Address: BUCHANAN, INGERSOLL & ROONEY PC, POST OFFICE BOX 1404, ALEXANDRIA, VA, 22313-1404, US

(73) Assignee: ALSTOM Technology Ltd., Baden (CH)

(21) Appl. No.: 11/812,029

(22) Filed: Jun. 14, 2007

Related U.S. Application Data
(63) Continuation of application No. PCT/EP05/56294, filed on Nov. 29, 2005.

(30) Foreign Application Priority Data
Dec. 21, 2004 (EP) 04106808.1

(51) Int. Cl. F03B 3/06

(52) U.S. Cl. 415/129

(57) ABSTRACT

At least one additional blade is arranged in the blade ring of at least one row of blades in order to improve the flow stability in a turbocompressor. This reduces the separation ration, and improves the flow stability.

### RELATED APPLICATIONS

This application claims priority under 35 U.S.C. §119 to EP Application 04106808.1 filed in Europe on Dec. 21, 2004, and as a continuation application under 35 U.S.C. §120 to PCT/EP2005/056294 filed as an International Application on Nov. 29, 2005, designating the U.S., the entire contents of which are hereby incorporated by reference in their entireties.

### TECHNICAL FIELD

The disclosure relates to a method for individual modification of a turbocompressor for the purpose of matching to specific constraints during operation. The method can be used in particular for multistage axial turbocompressors. The disclosure also relates to components of a turbocompressor which are modified with the aid of the stated method, and to a turbocompressor, as well as to a gas turbine set, which have a turbocompressor such as this.

### BACKGROUND INFORMATION

Compressors in gas turbine sets and in particular air-breathing gas turbine sets have to ensure stable operation over a very wide operating range. This is due on the one hand to the broad spectrum of the environmental conditions. On the other hand, in the case of single-shaft gas turbine sets which are used for electricity generation, it is not possible to control the operating state of the compressor independently via the rotation speed. In contrast, machines which are used in low-power networks, such as those which typically occur in third-world countries, have to run with predetermined large fluctuations in the frequency and thus in the rotation speed resulting from the network, and frequently at a less than normal rotation speed, which makes the stability poorer. Furthermore, the ageing, the wear and the dirt on the compressor blades over the life of a compressor can also lead to a deterioration in the stability behavior. In the case of installations in which poor constraints such as these occur relatively frequently and accumulate, it is frequently desirable to modify the compressor in a gas turbine set that is provided per se, in such a way that it has better stability against flow separation.

When designing gas turbine sets, the compressor must be able to operate with very high efficiency levels. However, this can result in the compressor being operated close to the stability limit in extreme conditions, for example in the case of relatively low compressor inlet temperatures, which intrinsically improve the stability, as a result of the rising pressure ratio that is predetermined by the turbine, or else in very high compressor inlet temperatures resulting in the operating point of the compressor being shifted to a range which is now stable only conditionally. The stability margin may then no longer be sufficient to cover further disadvantageous influencing variables mentioned above.

For various reasons, it is obviously impracticable and in many cases too complex to completely match the compressors of gas turbine sets for specific constraints such as these. On the one hand, a completely new design of the blade section geometry for specific cases is uneconomic. On the other hand, it is virtually intrinsically impossible for individual installations to deviate from the standard rotor and/or stator geometry. Furthermore, the stability limit is frequently relevant only when an increase in power, and hence also in general an increase in the pressure ratio, is implemented during the course of a life of a gas turbine set, owing to improvements in the operating concept or in the turbine.

One situation which also occurs in the case of other compressor installations, for example in the case of industrial compressors, is that the margin from flow separation is no longer adequate as a result of changes in the operating regime. According to the prior art, this requires complete replacement of the compressor or highly complex modifications, which also require subsequent machining, which generally cannot be carried out in situ, of rotor and/or stator parts, or even their replacement.

In order to improve the flow stability of a turbomachine, in terms of the oscillatory response, U.S. Pat. No. 6,379,112 discloses the technical teaching of taking precautions in the design of the machine against the risk of oscillations in the blade cascade in that a row of blades, irrespective of whether this is a row of rotor blades in the rotor or a row of stator blades in the stator, is split over its circumference into different segments, e.g., into four quadrants, with a different number of blades being installed within each of these segments. Because of the changing blade separations over the circumference, the blades in the respective subsequent row of blades moving past are excited at continuously changing frequencies, thus reducing their tendency to oscillate. A refinement such as this to areas which are at risk of oscillation within the blade cascade is intended to reduce the overall tendency to oscillate. However, this document provides no stimuli with regard to the problem explained in the introduction of matching the turbomachine to specific constraints of operation at the boundary of the stability limit.

### SUMMARY

A method is disclosed which, on the basis of one of many aspects, allows the operating behavior of a turbocompressor to be matched to specific constraints and, in particular, allows the flow stability of the turbocompressor to be improved, without having to carry out modifications to the rotor shaft or to the casing. According to a further exemplary aspect, it is likewise intended to be possible to improve the flow stability of the turbocompressor without having to configure and verify new blade section geometries.

The disclosure makes it possible to vary the separation ratio of an axial blade cascade without having to modify the geometry of the blade sections, and in particular without having to modify components such as the rotor shaft or the casing.

The separation ratio of the blade cascade in an axial row of blades or in a blade ring is defined as the mutual offset between two blade sections in the circumferential direction, with respect to the chord length of a blade section.

It is known that an optimum separation ratio exists, as a function of the cascade load characteristic variable of the blade cascade, at which the losses are minimized. Deviations from this optimum separation ratio lead to a rapid rise in the cascade losses. Modern turbocompressors are configured to operate in the region of this optimum separation ratio. Within the scope of the invention, it has now been found that a reduction to the separation ratio of an existing compressor makes it possible to improve the flow stability within the compressor. However, this change represents major intervention in the cascade geometry of an axial row of blades. It has also been found that a modification which would increase the losses of an entire range of compressors as a result of stability problems in extreme operating conditions should be avoided. It has also been found that interventions in the blade section geometry are in their own right intrinsically complex and frequently necessitate major design changes or conversions to the rotor shaft and/or to the casing.

A method for improving the flow stability of a turbocompressor is thus specified, in which the number of blades arranged in a row of blades or in a blade ring in an axial blade cascade is increased. This reduces the distance between the two blade sections, and the separation ratio is also reduced without any modification to the blade section geometry, that is to say shifting to admittedly greater cascade losses but also to better stability.

The proposed method can be implemented in a particularly simple form if the blade feet of the blades which are arranged in a blade ring are arranged in a groove, which runs in the circumferential direction, in a rotor shaft or in a casing.

According to one exemplary embodiment of the method, at least one spacer which is arranged in the circumferential direction between two blade feet of the blade ring is removed, and at least one additional blade is inserted in its place. In a further exemplary embodiment, at least one spacer which is arranged between two blade feet in the blade ring is replaced by a spacer with a smaller circumferential extent, and at least one additional blade is installed. In another development in the method, at least one existing spacer is removed and is machined in such a way that the circumferential extent of the spacer is reduced; the spacer which has been modified in this way is installed again, and at least one additional blade is inserted into the blade ring. One obvious advantage in this case, in which only spacers have to be replaced and/or machined, is that the blades which are loaded both aerodynamically and by centrifugal forces do not need to be modified in their particularly heavily loaded foot area. In general, this modification is based solely on the replacement or the omission, or possibly remachining, of components which are comparatively easy to handle from the production point of view. This type of modification to blade rings, in which spacers are arranged between blade feet in the circumferential direction, is thus particularly economic.

One exemplary method, which can be used alternatively or cumulatively, is distinguished by the replacement of at least one existing blade by a blade whose blade foot has a smaller circumferential extent, and the insertion of at least one additional blade into the blade ring. This method may also include the removal of an existing blade and the machining of its blade foot in such a way that the circumferential extent of the blade foot is reduced. Following the modification of the blade foot, the blade is installed again, together with an additional blade.

In developments of the exemplary methods described above, blades whose blade section has the same chord length and in particular the same blade section geometry as the originally installed blades are used as additional blades and/or possibly as replacement blades to be installed. In particular, in one specific development of the method, identical blades are installed as additional blades with the originally installed blades. A modification of the blade foot may also be carried out to these intrinsically identical blades to be installed additionally, with the circumferential extent of the blade foot being reduced in comparison to the original state. This means that the only cascade characteristic variable which has changed is the separation ratio. This keeps the effort that is required for the modification low since, depending on the specific situation, it may not be necessary to replace all of the blades in the modified blade ring, and there is no need to reconfigure the blade section geometry. Furthermore, the effects on the flow conditions at the blade boundary which is arranged downstream remain minimal. In one exemplary embodiment of the method, after the conversion work, blades with an identical chord length of the blade section and in particular with an identical blade section geometry are arranged throughout the entire blade ring.

One major advantage of the exemplary method described here is that compressors can be modified individually and in situ in order to be matched to specific constraints during operation without any need for modifications to large components, which can be handled only with difficulty, such as the rotor shaft and/or the casing. The method can be carried out in such a way that only standard production components are required for this purpose, with modifications which can be carried out easily, such as milling off the blade foot, which can be carried out easily. Furthermore, it is not necessarily essential to replace all of the blades in the blade ring, and it may be sufficient to supply the blades that are additionally to be installed as new, thus considerably simplifying the logistics, particularly in the case of installations in regions where access is difficult.

The described exemplary method makes it possible to overcome stability problems in compressors, which are observed as a result of the occurrence of poor operating states and/or ageing and/or wear phenomena, with comparatively little effort.

The exemplary method described above also makes it possible to optimize turbocompressors for normal use, since the described method makes it possible to very easily modify a compressor which is intended for unusual and extreme operating conditions to have a more stable operating behavior.

The specific embodiments of the exemplary methods as described above may, of course, be combined with one another.

The exemplary method can be suitable for modification of at least one row of blades in the rotor and/or the stator of a turbocompressor. In particular, the method is suitable for modification of a turbocompressor in a gas turbine set. The disclosure to this extent also covers a rotor for a turbocompressor and/or a stator for a turbocompressor having at least one row of blades, which are modified in accordance with the method described above. It also covers a turbocompressor which has a rotor and/or stator that has been modified by means of the method.

Further exemplary embodiments and applications of the disclosure will be evident to a person skilled in the art on the basis of the statements that have been made above and of the exemplary embodiment that is described in the following text, as well as from the patent claims.

### BRIEF DESCRIPTION OF THE DRAWINGS

The invention will be explained in more detail in the following text with reference to one exemplary embodiment, which is illustrated in the drawing, in which, in detail:

FIG. 1 shows an exemplary gas turbine set;

FIG. 2 shows one exemplary stage of an axial turbocompressor with compressor blades arranged in a circumferential groove;

FIG. 3 shows a different view of the stage illustrated in FIG. 2; and

FIG. 4 shows a tabular summary of the modifications to an exemplary 17-stage axial turbocompressor.

Details that are not significant to the invention have been omitted. The exemplary embodiments and the drawing are intended to assist understanding of the method specified here and should not be used to restrict the invention described in the claims.

### DETAILED DESCRIPTION

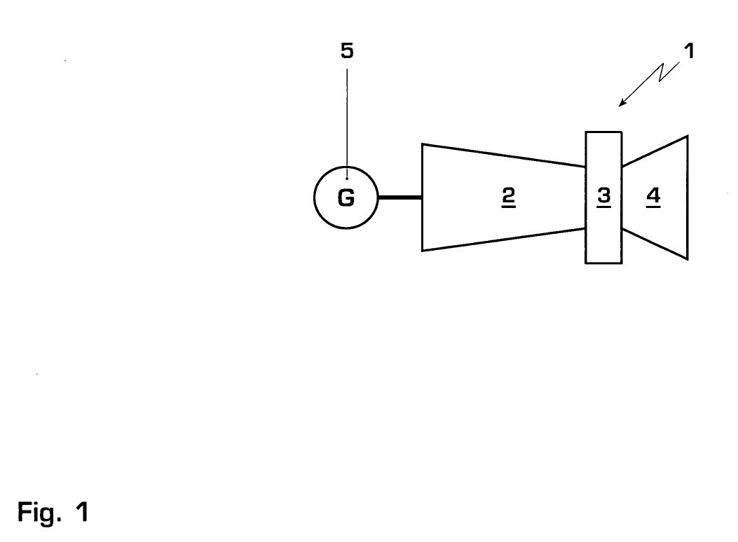

FIG. 1 illustrates an exemplary gas turbine set 1 which has a compressor 2, a combustion chamber 3 and a turbine 4. The gas turbine set which is illustrated by way of example is used to drive a generator 5 for electricity generation. In a manner which is not illustrated but will be familiar to those skilled in the art, the compressor 2 has a rotor, having a rotor shaft with rotor blades, as well as a stator with stator blades, which are normally arranged in the casing. When the generator is connected to the electricity network, any frequency change in the network results directly in a change in the rotation speed of the gas turbine set. The following statements describe the invention on the basis of the rotor in a compressor; the statements can be transferred to a stator in a manner which is immediately obvious to a person skilled in the art, for which reason an explicit explanation and illustration of the invention on the basis of a compressor stator is superfluous.

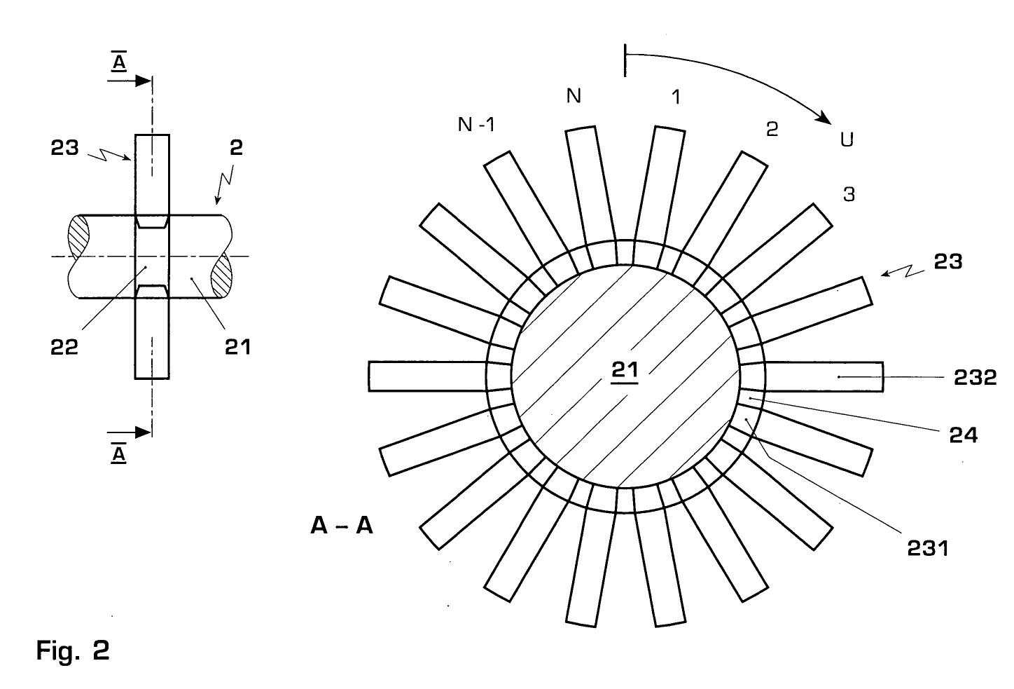

FIG. 2 illustrates a part of a rotor of an exemplary compressor having one row of blades. The rotor includes the rotor shaft 21. A circumferential groove 22 is incorporated in the rotor shaft, in which the rotor blades 23 of the row of rotor blades are arranged. The arrangement of the rotor blade ring can be seen along the line marked A-A in the illustration of a cross section. A blade 23 has a blade foot 231 and a blade section 232. Blade feet 231 and spacers 24 are arranged alternately in the circumferential groove 22 in the rotor shaft 21. The blade ring comprises N blades. U denotes the circumferential direction of the blade ring.

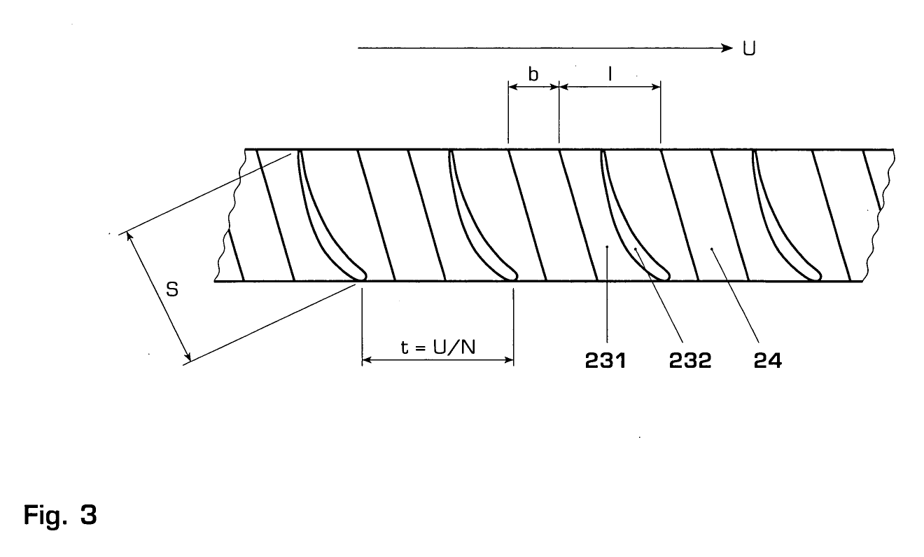

The detailed arrangement of blade feet 231 and spacers 24 in the circumferential groove and of the blade sections 232 can be seen in the development illustrated in FIG. 3. The extent of a blade foot in the circumferential direction is annotated I. The extent of a spacer in the circumferential direction is annotated b. These dimensions are in each case indicated on the outer circumference of the rotor shaft. The blade separation, that is to say the distance between two blade sections in the circumferential direction, is annotated t. This dimension varies over the blade height, of course; the chord length of a blade section is also likewise not necessarily constant over the entire blade height. Those skilled in the art will be familiar with the use of these dimensions for example in the mid-section to characterize a blade cascade. However, these values are not relevant as absolute values for the purposes of the following statements. The separation ratio t/e is a critical cascade characteristic variable, as those skilled in the art will be aware. As the separation ratio decreases, the wall friction losses of the flow in the blade cascade increase. If the separation ratio is very high, the losses increase owing to the increasingly inefficient flow direction change. Furthermore, the tendency to flow separation increases in compressor. In between there is an optimum separation ratio at which the losses are at a minimum, and for which a blade cascade is normally at least approximately designed. The optimum separation ratio is a function of a cascade load characteristic variable and can be determined without any problems by those skilled in the art. In the case of the method proposed here, use is now made of the knowledge that reducing the separation ratio reduces the separation tendency in a turbocompressor, allowing its operating range to be widened. Knowledge of the described method makes it possible to optimize the losses in turbocompressors which are used, for example, as compressors in gas turbine sets, in such a way that they operate with very low losses in an operating range which occurs frequently, for example in more than 70% of all applications. Capability to improve the operating stability of the turbocompressor without any configuration changes makes it possible, inter alia, to implement this configuration without any compromises, meaning that less attention need be paid to extreme operating conditions than was normal until now. The proposed method makes it possible to individually modify individual compressors in a range without any problems in comparison to the standard configuration, and to match them to specific operating conditions. By way of example, compressors in gas turbine sets which are operated at very high ambient temperatures are subject to problems relating to stable operation and, where possible, they frequently have to be operated at a reduced rotation speed in low-power electricity networks. This is further accentuated if the gas turbine set is operated with water and/or steam injection into the combustion chamber in order to maintain the power at high ambient temperatures, so that the pressure ratio against which the compressor has to work also rises. According to the method proposed here, the stable operating range of the compressor is widened by increasing the number of blades arranged in the blade ring in at least one row of blades, and thus reducing the separation ratio. By way of example, in the arrangement illustrated in FIG. 3, the spacers 24 are removed, the blades are pushed together, and additional blades are arranged. In the exemplary embodiment, there is space for N·b/l additional blades; the separation ratio is reduced from t=U/N to t=u/(N·(1+b/l)). If the number of additional blades resulting from this calculation is not an integer, then the rest of the circumferential extent can be bridged by a closure piece in a manner which is known per se to those skilled in the art. The statements made above and the dependent claims disclose further options which can be used alternatively or cumulatively in order to increase the number of blades arranged in a blade ring whose circumference is U.

One exemplary embodiment of the method comprises the number of blades in the third rotor row in an axial turbocompressor being increased from 41 to 45.

One exemplary embodiment of the method comprises the number of blades in the fourth rotor row in an axial turbocompressor being increased from 41 to 45.

One exemplary embodiment of the method comprises the number of blades in the fifth rotor row in an axial turbocompressor being increased from 41 to 45.

One exemplary embodiment of the method comprises the number of blades in the 6th rotor row in an axial turbocompressor being increased from 51 to 57.

One exemplary embodiment of the method comprises the number of blades in the 7th rotor row in an axial turbocompressor being increased from 51 to 57.

One exemplary embodiment of the method comprises the number of blades in the 8th rotor row in an axial turbocompressor being increased from 51 to 57.

One exemplary embodiment of the method comprises the number of blades in the 9th rotor row in an axial turbocompressor being increased from 65 to 71.

One exemplary embodiment of the method comprises the number of blades in the 10th rotor row in an axial turbocompressor being increased from 65 to 71.

One exemplary embodiment of the method comprises the number of blades in the 11th rotor row in an axial turbocompressor being increased from 65 to 71.

One exemplary embodiment of the method comprises the number of blades in the 12th rotor row in an axial turbocompressor being increased from 65 to 71.

One exemplary embodiment of the method comprises the number of blades in the 13th rotor row in an axial turbocompressor being increased from 65 to 71.

One exemplary embodiment of the method comprises the number of blades in the 14th rotor row in an axial turbocompressor being increased from 83 to 91.

One exemplary embodiment of the method comprises the number of blades in the 15th rotor row in an axial turbocompressor being increased from 83 to 91.

One exemplary embodiment of the method comprises the number of blades in the 16th rotor row in an axial turbocompressor being increased from 83 to 91.

One exemplary embodiment of the method comprises the number of blades in the 17th rotor row in an axial turbocompressor being increased from 83 to 91.

One exemplary embodiment of the method comprises increasing the number of blades in the first stator row of an axial turbocompressor from 34 to 38. In this case, the first stator row is not the same as a row of inlet guide vanes; the first stator row means the stator blade row which is arranged immediately downstream from the first rotor blade row.

One exemplary embodiment of the method comprises the number of blades in the second stator row in an axial turbocompressor being increased from 46 to 50.

One exemplary embodiment of the method comprises the number of blades in the third stator row in an axial turbocompressor being increased from 52 to 54.

One exemplary embodiment of the method comprises the number of blades in the fourth stator row in an axial turbocompressor being increased from 52 to 54.

One exemplary embodiment of the method comprises the number of blades in the fifth stator row in an axial turbocompressor being increased from 60 to 64.

One exemplary embodiment of the method comprises the number of blades in the sixth stator row in an axial turbocompressor being increased from 56 to 62.

One exemplary embodiment of the method comprises the number of blades in the 7th stator row in an axial turbocompressor being increased from 52 to 58.

One exemplary embodiment of the method comprises the number of blades in the 8th stator row in an axial turbocompressor being increased from 66 to 72.

One exemplary embodiment of the method comprises the number of blades in the 9th stator row in an axial turbocompressor being increased from 66 to 72.

One exemplary embodiment of the method comprises the number of blades in the 10th stator row in an axial turbocompressor being increased from 66 to 72.

One exemplary embodiment of the method comprises the number of blades in the 11th stator row in an axial turbocompressor being increased from 66 to 72.

One exemplary embodiment of the method comprises the number of blades in the 12th stator row in an axial turbocompressor being increased from 66 to 72.

One exemplary embodiment of the method comprises the number of blades in the 13th stator row in an axial turbocompressor being increased from 84 to 92.

One exemplary embodiment of the method comprises the number of blades in the 14th stator row in an axial turbocompressor being increased from 84 to 92.

One exemplary embodiment of the method comprises the number of blades in the 15th stator row in an axial turbocompressor being increased from 84 to 92.

One exemplary embodiment of the method comprises the number of blades in the 16th stator row in an axial turbocompressor being increased from 84 to 92.

One exemplary embodiment of the method comprises the number of blades in the 17th stator row in an axial turbocompressor being increased from 84 to 92.

In the case of these modifications, the blade section geometry in each case can remain unchanged. In a further exemplary embodiment, the original installed blades are reused, and additional blades are newly installed.

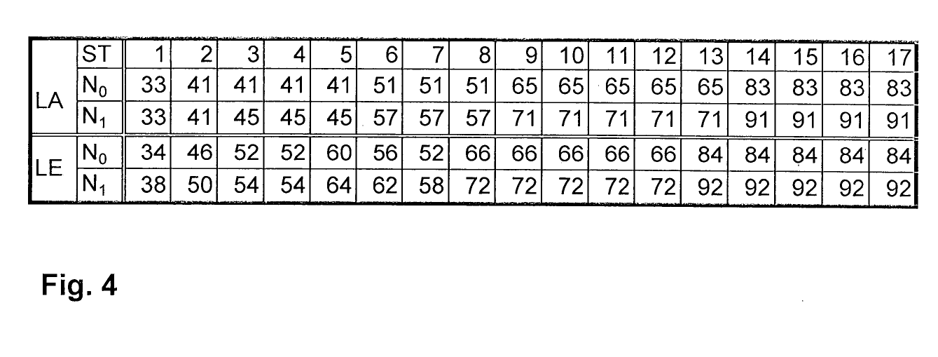

The exemplary embodiments described above may be combined with one another. In one exemplary embodiment, all of the rotor and stator blade rows in a compressor are modified as stated above, while the number of blades in the first two rows of rotor blades is kept constant. This then results in a compressor modification as indicated in the table in FIG. 4. In this case, a 17-stage axial turbocompressor has been modified in accordance with a method as characterized in the claims. The uppermost row denotes the stage number. LE denotes the stator rows, and LA denotes the rotor rows. N₀ denotes the number of blades in a blade ring before modification. N₁ denotes the number of blades in a blade ring after modification. In this way, the modification that has been carried out can be read from the comparison of the second and third as well as the fourth and fifth line.

In light of the statements made above and the patent claims, the way in which the method for modification of other compressors is carried out will be obvious to those skilled in the art.

It will be appreciated by those skilled in the art that the present invention can be embodied in other specific forms without departing from the spirit or essential characteristics thereof. The presently disclosed exemplary embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Gas turbine set
2 Compressor
3 Combustion chamber
4 Turbine
5 Generator
21 Rotor shaft
22 Circumferential groove
23 Blade
24 Spacer
231 Blade foot
232 Blade section
b Circumferential extent of a spacer
l Circumferential extent of a blade foot
s Chord length
t Separation dimension
LA Row of rotor blades
LE Row of stator blades
N Number of blades in a blade ring
N₀ Number of blades in the blade ring before modification
N₁ Number of blades in the blade ring after modification

What is claimed is:

1. A method for individual modification of a turbocompressor for the purpose of matching to specific constraints during operation, with the blade feet of blades which are arranged in a blade ring being arranged in a groove, which runs in the circumferential direction, in a rotor shaft or in a casing, wherein the number (N) of blades which are arranged in one blade ring being increased in an axial blade cascade of the compressor.

2. The method as claimed in claim 1, wherein the removal of at least one spacer, which is arranged between two blade feet of the blade ring in the circumferential direction (U), and the use of at least one additional blade.

3. The method as claimed in claim 1, wherein the replacement of at least one spacer which is arranged between two blade feet in the blade ring by a spacer with a smaller circumferential extent (b), and the use of at least one additional blade.

4. The method as claimed in claim 3, wherein the removal of at least one existing spacer, with this being machined such that the circumferential extent (b) is reduced, and by the modified spacer and at least one additional blade being installed again.

5. The method as claimed in claim 2, wherein the originally installed blades being left installed or these blades being removed and being installed again in an identical manner, or by the installed blades being replaced by identical blades.

6. The method as claimed in claim 1, wherein the replacement of at least one existing blade by a blade whose blade foot has a smaller circumferential extent, and the use of at least one additional blade.

7. The method as claimed in claim 6, wherein the removal of at least one existing blade and the machining of its blade foot in such a manner that the circumferential extent is reduced, and by the blade being installed again together with an additional blade.

8. The method as claimed in claim 1, wherein the additional blade being a blade whose blade section has the same chord length (s) as the originally installed blades.

9. The method as claimed in claim 1, wherein the additional blade being a blade which has the same blade section geometry as the originally installed blades.

10. The method as claimed in claim 1, wherein blades whose blade section has an identical chord length (s) being used for the entire blade ring.

11. The method as claimed in claim 1, wherein blades with an identical blade section geometry being used for the entire blade ring.

12. The method as claimed in claim 1, wherein an identical blade to an originally installed blade being installed as an additional blade.

13. The method as claimed in claim 1, wherein an identical blade to an originally installed blade being used as an additional blade, with the blade foot of the additional blade being machined in such a way that the circumferential extent is reduced, and by the installation of the blade which has been modified in this way.

14. A rotor of a turbocompressor, having at least one row of blades which has been modified in accordance with the method of claim 1.

15. A stator of a turbocompressor, having at least one row of blades which has been modified in accordance with the method of claim 1.

16. A turbocompressor, having at least one rotor or one stator as claimed in claim 14.

17. A gas turbine set having a turbocompressor as claimed in claim 16.

18. A rotor of a turbocompressor, having at least one row of blades which has been modified in accordance with the method of claim 13.

19. A stator of a turbocompressor, having at least one row of blades which has been modified in accordance with the method of claim 13.

20. A turbocompressor, having at least one rotor or one stator as claimed in claim 15.
